(19) United States
(12) Patent Application Publication
(10) Pub. No.: US 2025/0132925 A1
(43) Pub. Date: Apr. 24, 2025

(54) METHOD FOR RECORDING AND VERIFYING MEASURED VALVES, AND ASSOCIATED DEVICES AND MEASUREMENT ARRANGEMENT

(71) Applicant: Testo SE &Co., KGaA, Titisee-Neustadt (DE)

(72) Inventors: Lucas Flender, Ühlingen-Birkendorf (DE); Andreas Jordt, Kiel (DE)

(73) Assignee: Testo SE &Co., KGaA, Titisee-Neustadt (DE)

(21) Appl. No.: 18/919,549

(22) Filed: Oct. 18, 2024

(30) Foreign Application Priority Data
Oct. 20, 2023 (EP) 23205064.1

(51) Int. Cl. H04L 9/32

(52) U.S. Cl. CPC H04L 9/3247

(57) ABSTRACT

A method for recording a field (1) of measured values (2) is provided, in which the measured values (2) are grouped into blocks (5) and signature values (6) are calculated for each block (5), wherein at least one block (5a) contains a measured value (2′) which is also contained in at least one other block (5b). Such a method can be carried out in particular with a measurement arrangement (21), recording device (15) and verification device (18).

### CROSS-REFERENCE TO RELATED APPLICATIONS

This application claims priority to European Patent Application No. 23205064.1, filed Oct. 20, 2023, which is incorporated herein by reference as if fully set forth.

### BACKGROUND

The invention generally relates to a method for recording a field of measured values, wherein the field of measured values has, for each measured value, at least one measurement datum and an associated position indication in the field, wherein the measured values are grouped into blocks and a signature value is calculated for each block. Such a method is widely used in practice.

The invention further generally relates to a method for verifying a field of measured values, wherein the field of measured values is grouped into blocks and a signature value is provided for each block, wherein the signature values are verified. Such methods are known in practice.

The invention further generally relates to a recording device for measured values, wherein a field of measured values can be input, wherein the field of measured values has, for each measured value, at least one measurement datum and an associated position indication in the field, wherein the measured values can be grouped into blocks using a grouper and a signature value can be calculated for each block using a signer. Such a device is known in practice.

The invention further generally relates to a verification device for measured values, wherein a field of measured values which is grouped into blocks can be input, wherein a signature value can be input for each block, wherein a verifier is configured to verify the signature values. Such devices are known in practice.

The invention further generally relates to a measurement arrangement having at least one sensor which is configured to generate a field of measured values, wherein the field of measured values has, for each measured value, at least one measurement datum and an associated position indication in the field. Such a measurement arrangement is known in practice.

### SUMMARY

The invention is based on the object of protecting measurement data from manipulation and reducing the required storage requirement.

In order to achieve this object, the invention provides one or more of the features disclosed herein. In particular, it is thus provided, according to the invention, in a method for recording a field of measured values of the type described at the outset, that at least one block contains at least one measured value which is also contained in at least one other block.

This allows said blocks to be concatenated such that unnoticed deletion of individual blocks of measured values together with their signatures can be avoided. This is because the absence of individual blocks would be apparent thanks to those measured values which are also contained in other blocks. Manipulation of captured measurement data is thus made more difficult.

It is possible to overlap or interleave two blocks by means of a single common measured value in each case, or more than one measured value is shared in each case.

In one advantageous embodiment, provision may be made for the at least one measured value to be arranged at a fixed position in the at least one block.

Thanks to this arrangement, it is easy to identify which measured value of the at least one block should be searched for in the at least one other block.

Alternatively or additionally, provision may be made for the at least one measured value to be arranged at a fixed position in the at least one other block.

This makes it easy to search for the corresponding measured value in the at least one other block and makes it easy to identify whether blocks of measured values have been deleted.

In a further advantageous embodiment, provision may be made for the at least one measured value to be arranged at an edge position in the at least one block. This can be used to facilitate a subdivision of a sequence or field of measured values into interleaved blocks.

For example, this may be an end position. This is advantageous because in this way the at least one measured value, which is to be searched for in the at least one other block, is easy to identify. This facilitates the process of verifying the measurement data.

Alternatively or additionally, provision may be made for the at least one measured value to be arranged at an edge position in the at least one other block. This can facilitate concatenation or interleaving of adjacent blocks.

For example, this may be a starting position. This makes it easy to identify whether the at least one measured value is contained in the at least one other block, since only the respective edge position needs to be checked. In this way, it can be ensured that the measured values are completely present in a complete sequence and, in particular, that individual blocks of measured values have not been deleted.

In a further advantageous configuration, provision may be made for the position of the at least one measured value in the at least one block to be determined from the associated position indication.

The advantage of this configuration is that the arrangement of the measured values in the respective block corresponds to the arrangement in the field of measured values, with the result that these can be easily assigned.

Alternatively or additionally, provision may be made for the position of the at least one measured value in the at least one other block to be determined from the associated position indication.

This makes it easier to compare whether the at least one measured value is present in the corresponding blocks.

In a further advantageous configuration, provision may be made for each block to be formed from a group of measured values that is contiguous with respect to the field.

This makes it possible to ensure that the blocks are not composed of randomly selected measured values, but that these sections of the field of measured values correspond. This can lead to better clarity, which in turn can lead to possible manipulation of the measurement data being detected more quickly.

In a further advantageous configuration, provision may be made for the field to be one-dimensional.

The sequence of the measurement data is thus unambiguous and individual blocks of measurement data can be better compared with each other. This variant is easy to use for one-dimensional numerical sequences, for example time measurement series. The method is therefore easy to use with data loggers.

In a further advantageous configuration, provision may be made for the position indication to be determined by a measurement time.

This configuration can be used to check whether there is a complete sequence of the measured values. It is thus also easy to use measurement series of a data logger.

In a further advantageous configuration, provision may be made for a hash value of the block to be calculated for the signature value.

This makes it possible to reduce the storage size of the signature because the size of a hash value can be limited.

In a further advantageous configuration, provision may be made for the measurement data to be read out from at least one sensor. Thus, the invention can be used for measurement data from a data logger.

This means that the measurement data can be protected from manipulation immediately after the measurement.

A measurement time is preferably determined and processed to form a position indication in the field. Thus, the invention can also be used in typical areas of application of data loggers.

The measurement time as a position indication facilitates the subsequent process of verifying the signed measurement data.

In a further advantageous configuration, provision may be made for a new grouping into blocks to be formed for an existing grouping into blocks, wherein at least one block in the new grouping is formed from at least two blocks in the old grouping.

It is advantageous that the storage requirement for signatures can be reduced because the number of signatures to be stored is also reduced by combining blocks.

Preferably, at least one block in the new grouping is formed from at least two blocks that have at least one measured value in common.

This is particularly advantageous if the at least one measured value in the blocks is arranged at edge positions, for example the starting and end positions. In this arrangement, the respective blocks of measured values are adjacent. When these blocks are combined, it is therefore possible to create a new block whose measured values form a complete measurement series.

Particularly preferably, the at least one common measured value is only singly included in the block in the new grouping.

By avoiding redundant measured values in a block in this way, the required storage space can be reduced.

Alternatively or additionally, in order to achieve the stated object, the features of the coordinate claim, which is directed to a method for verifying a field of measured values, are provided according to the invention. In particular, in order to achieve the stated object in a method for verifying a field of measured values of the type described at the outset, it is therefore proposed according to the invention that, for at least one block of the blocks, it is checked whether at least one measured value is also contained in at least one other block. A method according to the invention for verifying a field of measured values can be advantageously subsequently used to carry out a method as described above or subsequently claimed for recording a field of measured values.

This method can be used to check whether the at least one other block has been deleted, since in that case the at least one measured value could not be found in another block.

Alternatively or additionally, in order to achieve the stated object, the features of the coordinate claim, which is directed to a recording device for measured values, are provided according to the invention. In particular, in order to achieve the stated object in a recording device for measured values of the type described at the outset, it is therefore proposed according to the invention that the grouper is configured in such a way that at least one block contains at least one measured value which is also contained in at least one other block.

It is advantageous here that the measurement data can be protected from manipulation and in particular the unnoticed deletion of individual blocks can be avoided, since the blocks are connected to each other by overlapping measured values.

In one advantageous configuration, provision may be made for means to be designed to carry out a method as described above.

This allows the advantages described above to be applied to a recording device.

Alternatively or additionally, in order to achieve the stated object, the features of the coordinate claim, which is directed to a verification device for measured values, are provided according to the invention. In particular, in order to achieve the stated object in a verification device for measured values of the type described at the outset, it is therefore proposed according to the invention that a checker is configured to check whether at least one block contains at least one measured value which is also contained in at least one other block.

This is advantageous in order to check whether individual signed blocks have been removed, since in that case the at least one measured value could not be found in the at least one other block.

In one advantageous configuration, provision may be made for means to be designed and/or configured to carry out a method as described above.

This allows the advantages described above to be applied to a recording device.

Alternatively or additionally, in order to achieve the stated object, the features of the coordinate claim, which is directed to a measurement arrangement, are provided according to the invention. In particular, in order to achieve the stated object in a measurement arrangement of the type described at the outset, it is therefore proposed according to the invention, that a recording device as described above is formed.

This allows the advantages described above to be applied to a measurement arrangement.

Preferably, the recording device is connected to the at least one sensor in such a way that the generated field of measured values is input into the recording device.

In this way, the measured values can be protected from possible manipulation, in particular from deletion of blocks of measured values, immediately after the measurement process.

### BRIEF DESCRIPTION OF THE DRAWINGS

The invention will now be described in more detail on the basis of exemplary embodiments, but is not restricted to these exemplary embodiments. Further exemplary embodiments arise from combining the features of individual or multiple claims with one another and/or with individual or multiple features of the exemplary embodiments.

In the figures:

FIG. 1 shows a measurement arrangement 21 comprising a sensor 13 and a recording device 15, which comprises means for carrying out a method according to the invention,

FIG. 2 shows two different groupings 14a, 14b of blocks 5d, 5e of measured values 2, 2′, and

FIG. 3 shows a verification device 18 for carrying out a method according to the invention.

### DETAILED DESCRIPTION

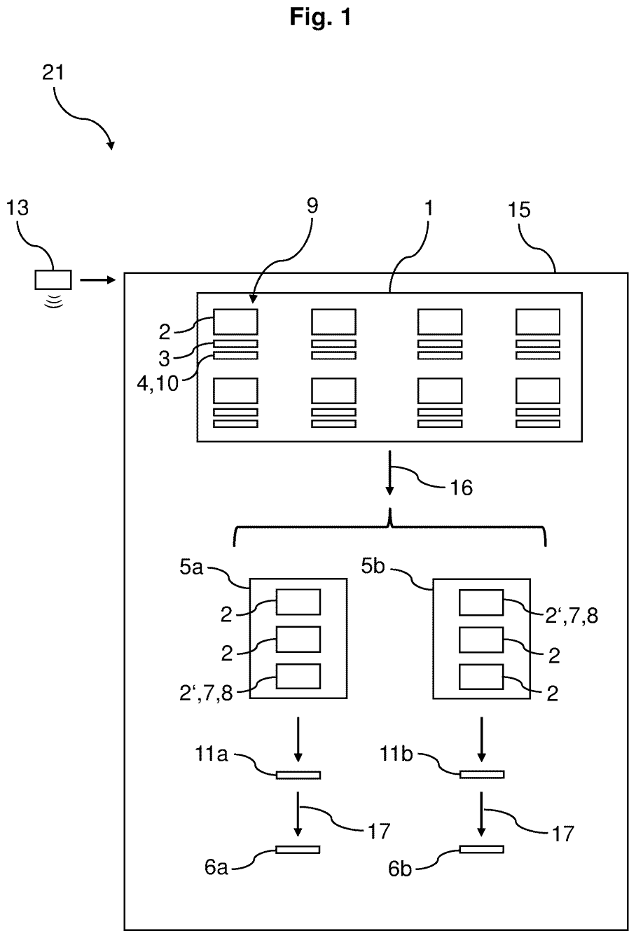

A measurement arrangement 21 can be seen in FIG. 1. A sensor 13 generates a field 1 of measured values 2, which is input into a recording device 15, which can be formed by a processor and a memory. The measured values 2 are arranged in a group 9 and each have a measurement datum 3 and a position indication 4. The position indication 4 is a measurement time 10 in this exemplary embodiment.

The measured values 2 are combined into two blocks 5a, 5b by means of a grouper 16, for example formed by programming executed by the processor. The same measured value 2′ is contained in both blocks. The position 7 of this measured value 2′ is an edge position 8 here-the measured value 2′ is placed at an end position in the block 5a and at a starting position in the block 5b.

Hash values 11a, 11b are calculated for each of the blocks 5a, 5b. Signers 17, for example formed by programming executed by the processor, are then used to calculate signature values 6a, 6b for each of the hash values 11a, 11b.

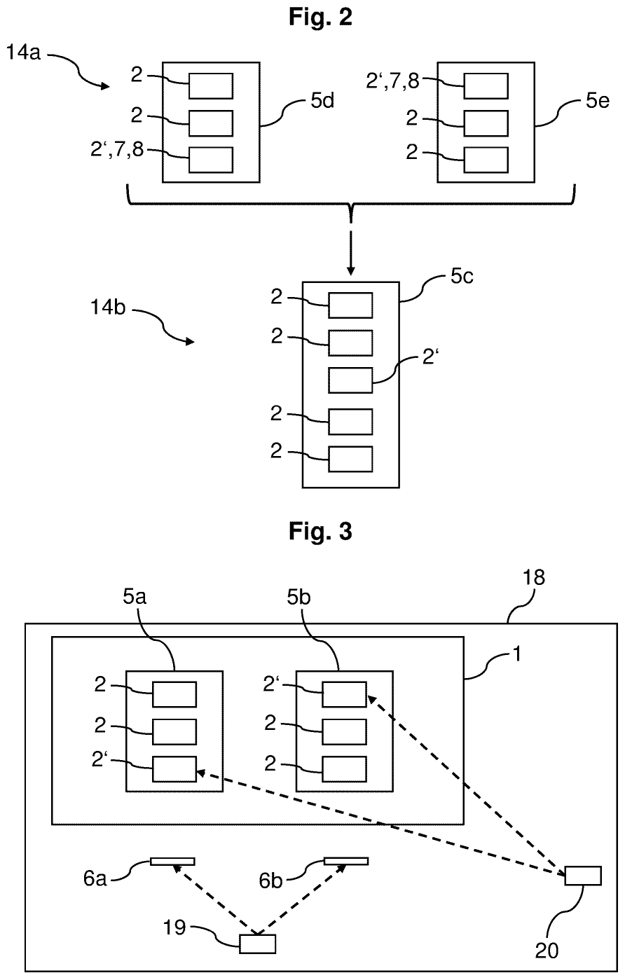

FIG. 2 shows a grouping 14a of blocks 5d, 5e of measured values 2. Both blocks 5d, 5e contain the measured value 2′, the position 7 of which is determined by an edge position 8 in the respective block 5d, 5e.

In the next step, the blocks 5d, 5e are formed into a new grouping 14b which comprises the block 5c. The new block 5c contains the measured values 2 of the blocks 5d, 5e in the old grouping. However, the measured value 2′ is only included once in the block 5c.

FIG. 3 shows a verification device 18 which comprises a verifier 19 and a checker 20, both for example being formed by programming that is executed by the processor. A field 1 of blocks 5a, 5b of measured values 2, 2′ has been input into the verification device 18. For each block 5a, 5b, a signature value 6a, 6b has also been input.

The verifier 19 verifies the signature values 6a, 6b of the blocks 5a, 5b. The checker 20 checks whether there is a measured value 2′ that is contained in both blocks 5a, 5b.

The invention generally proposes a method for recording a field 1 of measured values 2, in which the measured values 2 are grouped into blocks 5 and signature values 6 are calculated for each block 5, wherein at least one block 5a contains a measured value 2′ which is also contained in at least one other block 5b. Such a method can be carried out in particular with a measurement arrangement 21, recording device 15 and verification device 18 according to the invention.

### LIST OF REFERENCE SIGNS

1 Field (of 2)

2 Measured value

3 Measurement datum

4 Position indication

5 Block

6 Signature value

7 Position (of 2 in 5)

8 Edge position

9 Group (of 2)

10 Measurement time

11 Hash value

12 Measurement data

13 Sensor

14 Grouping

15 Recording device

16 Grouper

17 Signer

18 Verification device

19 Verifier

20 Checker

21 Measurement arrangement

1. A method for recording a field (1) of measured values (2), wherein the field (1) of measured values (2) has, for each measured value (2), at least one measurement datum (3) and an associated position indication (4) in the field (1), the method comprising:
grouping the measured values (2) into blocks (5); and
calculating a signature value (6) for each block (5), wherein at least one of the blocks (5a) contains at least one of the measured values (2′) which is also contained in at least one other one of the blocks (5b).

2. The method as claimed in claim 1, wherein the at least one measured value (2′) is arranged at a fixed position (7) in at least one of the at least one block (5a) or the at least one other block (5b).

3. The method as claimed in claim 2, wherein the at least one measured value (2′) is arranged at an edge position (8) in the at least one of the at least one block (5a) or the at least one other block (5b).

4. The method as claimed in claim 2, further comprising determining the fixed position (7) of the at least one measured value (2′) in the at least one of the at least one block (5a) or the at least one other block (5b) from the associated position indication (4).

5. The method as claimed in claim 1, further comprising forming each block (5) from a group (9) of the measured values (2) that is contiguous with respect to the field (1).

6. The method as claimed in claim 5, wherein the field (1) is one-dimensional.

7. The method as claimed in claim 1, further comprising determining the position indication (4) by a measurement time (10).

8. The method as claimed in claim 1, further comprising calculating a hash value (11) of the block (5) for the signature value (6).

9. The method as claimed in claim 1, further comprising reading out measurement data (12) from at least one sensor (13) to form the position indication (4) in the field (1).

10. The method as claimed in claim 9, further comprising determining and processing a measurement time (10) as the measurement data (12) to form the position indication (4) in the field (1).

11. A method for recording a field (1) of measured values (2), wherein the field (1) of measured values (2) has, for each measured value (2), at least one measurement datum (3) and an associated position indication (4) in the field (1), the method comprising:
grouping the measured values (2) into blocks (5);
calculating a signature value (6) for each of the blocks (5);
forming a new grouping (14b) into blocks (5) for an existing grouping (14a) into blocks (5), including forming at least one block (5c) in the new grouping (14b) from at least two of the blocks (5d, 5e) in the existing grouping (14a).

12. The method as claimed in claim 11, further comprising forming the at least one block (5c) in the new grouping (14b) from at least two of the blocks (5d, 5e) in the existing grouping (14a) from the at least two of the blocks (5d, 5e) in the existing grouping (14a) which have at least one measured value (2′) in common, and only singly including the at least one common measured value (2′) in the block (5c) in the new grouping (14b).

13. A method for verifying a field (1) of measured values (2), wherein the field (1) of measured values is grouped into blocks (5), the method comprising:
grouping the measured values (2) into blocks (5);
calculating a signature value (6) for each block (5), wherein at least one of the blocks (5a) contains at least one of the measured values (2′) which is also contained in at least one other one of the blocks (5b); and
verifying the signature value (6) for each block (5), by checking that, for least one block (5a) of the blocks (5), whether at least one measured value (2′) is also contained in at least one other block (5b).

14. A recording device (15) for measured values (2), the recording device comprising:
a processor configured such that a field (1) of measured values (2) is adapted to be input, wherein the field (1) of measured values (2) has, for each measured value (2), at least one measurement datum (3) and an associated position indication (4) in the field (1), the processor being further configured to group the measured values (2) into blocks (5) using a grouper (16) and to calculate a signature value (6) for each block (5) using a signer (17), wherein the grouper (16) is configured such that at least one of the blocks (5a) contains at least one measured value (2′) which is also contained in at least one other one of the blocks (5b).

15. A verification device (18) for measured values (2), the verification device comprising: a processor configured such that a field (1) of measured values (2) which is grouped into blocks (5) is adapted to be input, a signature value (6) is adapted to be input for each block (5), and a verifier (19) is configured to verify the signature values (6), and a checker (20) is configured to check whether at least one of the blocks (5a) contains at least one measured value (2′) which is also contained in at least one other one of the blocks (5b).

16. A measurement arrangement (21), comprising: at least one sensor (13) which is configured to generate a field (1) of measured values (2), wherein the field (1) of measured values (2) has, for each measured value (2), at least one measurement datum (3) and an associated position indication (4) in the field (1), and the recording device (15) as claimed in claim 14 is connected to the at least one sensor (13) such that the generated field (1) of measured values (2) is input into the recording device (15).
